(19) United States
(12) Patent Application Publication
(10) Pub. No.: US 2026/0192758 A1
(43) Pub. Date: Jul. 9, 2026

(54) Vehicle Slide Mount For Multiple Components

(71) Applicant: John Lazar, Bellport, NY (US)

(72) Inventor: John Lazar, Bellport, NY (US)

(21) Appl. No.: 19/338,934

(22) Filed: Sep. 24, 2025

Related U.S. Application Data
(63) Continuation-in-part of application No. 18/916,241, filed on Oct. 15, 2024.
(60) Provisional application No. 63/648,206, filed on Jun. 6, 2024.
(60) Provisional application No. 63/658,643, filed on Jun. 11, 2024.

(51) Int. Cl. B60R 11/02

(52) U.S. Cl. CPC B60R 11/0205

(57) ABSTRACT

The embodiment of the invention provides a combination bracket and electrical connector assembly for plural components for removable installation into a vehicle. The combination includes a bracket assembly that surrounds two or more stacked components, holding the components together. An upper connector assembly has a first housing and a bottom open face and has plural first connecting elements mounted into the first housing, the upper connecting assembly arranged for mounting onto a vehicle surface. A lower connector assembly has a second housing and a top open face and is arranged for mounting onto the bracket assembly, the lower connector assembly having plural second connecting elements mounted into the second housing. The plural first connecting elements arranged to automatically engage the plural second connecting elements when the lower connector assembly is slid under the upper connector assembly.

This application is a continuation-in-part of U.S. Ser. No. 18/916,241, filed Oct. 15, 2024 which claims the benefit of U.S. Provisional Application Ser. No. 63/658,643, filed Jun. 11, 2024 and U.S. Provisional Application Ser. No. 63/648,206, filed Jun. 6, 2024.

### BACKGROUND

Conventional and current technology limit installation of radios under dashboard or other locations using slide mounts to a single antenna radio. Current technology does not allow expansion of more advanced radios that need more than one antenna on a vehicle for multi-band use. Current technology does not provide for stacked components such as a radio and an amplifier in a stacked configuration. Current technology does not provide for multiple antennas using independent coaxial paths and instead use an expander such as a duplexer or triplexer that allow multi-share of the same communication coaxial path. Using an expander limits the best optimal transmissions and performance and Standing Wave Ratio (SWR) for different devices.

The present inventor has recognized that the best and optimal reception and transmission of a radio wave is to provide each band its own separate antenna coaxial path and antenna coaxial cable straight from the radio without compromising in sharing of the line with another band.

The present technology of single coaxial antenna slide mount is limited to this one radio and one antenna technology.

### SUMMARY

The exemplary embodiment of the present invention provides a mounting arrangement for stacked components such as multi-antenna-based radios, amplifiers, stereos, and GPS scanners.

Alternately, an exemplary embodiment provides a mounting arrangement for three components in a stack such as a radio, an antenna tuner and a signal amplifier. The arrangements provide for single-handed removal of the arrangement and components and an easy-to-use, automatic install of the stacked components. The arrangements can be used for under the dashboard or other locations having a single slide mount. The arrangements install and disconnect all radios, antenna tuners, signal amplifiers, scanners, power wires, antennas, public address (PA), GPS antenna, and accessories as applicable, in one pull. This has applications for all types of situations as a base station or in vehicles or boats and for all radio frequencies such as police and fire scanners and not limited to Amateur Radio Band (Ham), Citizens Band (CB), Family Radio Service (FRS), General Mobile Radio Service (GMRS), simple stereo receivers and amplifiers, or navigation systems.

The embodiment of the invention provides a combination bracket and electrical connector assembly for plural components for removable installation into a vehicle. The combination includes a bracket assembly that surrounds two, three or more stacked components, holding the components together. An upper connector assembly has a first housing and a bottom open face and has plural first connecting elements mounted into the first housing, the upper connecting assembly arranged for mounting onto a vehicle surface. A lower connector assembly has a second housing and a top open face and is arranged for mounting onto the bracket assembly, the lower connector assembly having plural second connecting elements mounted into the second housing. The plural first connecting elements arranged to automatically engage the plural second connecting elements when the lower connector assembly is slid under the upper connector assembly.

An embodiment can have two of the plural first connecting elements and two of the plural second connecting elements dedicated to connecting two antennas each dedicated to a different signal band. Alternately, an embodiment can have two of the plural first connecting elements and two of the plural second connecting elements dedicated to connecting a radio, an antenna tuner and a signal amplifier.

An exemplary embodiment of the present invention provides a slide mount for two or more components so that more than one coaxial line can be received from the radio in a non-shared separate radio communication line for each separate band. This would allow a separate antenna for each separate band for the radios. This would greatly improve communication reception and improve convenience at the same time.

Alternately, an embodiment of the present invention provides a slide mount for three specific components, a radio, an antenna tuner and a signal amplifier.

The slide mount would allow a radio to be auto-engaged to a radio antenna tuner in the stack of three components. This allows the tuner to achieve the lowest SWR between the radio and a single antenna and thus allowing tunable best SWR when changing frequency bands with just a single antenna. A tuner in the stack of components will give radio frequency flexibility to tune to multiple radio bands and frequencies using just one antenna thus eliminating a complicated array of antennas on the vehicle.

This configuration also allows an amplifier to be connected as well. The low SWR achieved by the setup is advantageous to engage a third device amplifier for a high-powered, amplified radio signal. A high SWR could otherwise cause major feedback of the boosted signal and thus burn out the radio.

By combining the three devices together will allow the radio to transmit with a long distance boosted signal at a lowest SWR for maximum communication. This slide mount configuration allows the three components to be removed together and moved to another vehicle as desired.

Additionally, the stacked convenience of having an additional component in the bracket would allow the convenience of the one-hand slide mount but room for having an amplifier to boost the signal right there in the same bracket. This way the entire radio and amplifier can be removed as one unit and can be stowed when not used.

Alternatively, the additional space could be used for something else such as another radio or an external speaker or navigation system and still retain the convenience of a one-hand easy slide in and out automatically connecting and disconnecting all wires and power supplies via the novel instant invention bracket.

Specifically, the exemplary embodiment of the invention enables a single slide bracket to supply more than one coaxial cable and space for an additional electronic device with included additional accessory wires for additional applications thus enabling any modern multi-band capable radio to be controlled easily in one pull.

This instant slide mount is in a clam-shell shape where the lower portion of the clam shell would be attached to the radio bracket that comes with the radio using simple screws and bolts and the upper counterpart of the clamshell would be attached to the underside of the dashboard or other chosen area. Then they can be attached by sliding the lower radio portion into the top portion, creating a single clamshell secure electrical and coaxial connection of all of the included wiring for the specific application such as CB, Ham radio, police scanners, etc.

This has an additional feature such that it would deter any theft as the radio now becomes easily stowed out of site when not in use. But with this new configuration, the same radio can be used in multiple vehicles by just sliding the radio into the upper part of the mount. The upper portion can be used in multiple locations so that the electronic device can be swapped from vehicle to vehicle effortlessly.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a schematic side view of the exemplary embodiment of the invention;

FIG. 2 is a schematic front view of the invention of FIG. 1;

FIG. 3 is a schematic plan view of a first connector assembly from FIGS. 1 and 2;

FIG. 4 is a schematic plan view of a second connector assembly from FIGS. 1 and 2; and

FIG. 5 is a schematic enlarged side view taken from FIG. 1.

FIG. 6 is a left side schematic view of an alternate bracket and component assembly;

FIG. 7 is a right side schematic view of the alternate bracket and component assembly of FIG. 6;

FIG. 8 is a front view of the alternate bracket and component assembly, with the componenets removed for clarity;

FIG. 9 is a rear view of the alternate bracket and component assembly, with the componenets removed for clarity;

FIG. 10 is an exploded right side view of the bracket assembly of FIG. 8;

FIG. 11 is an exploded left side view of the bracket assembly of FIG. 8;

FIG. 12 is a bottom view of a connector for mounting to a vehicle;

FIG. 13 is a front view of the connector of FIG. 12;

FIG. 14 is a top view of a connector that is mounted to a top of the bracket assembly;

FIG. 15 is a front view of the connector of FIG. 14; and

FIG. 16 is a front view of the connector of FIG. 12 engaged with the connector of FIG. 14.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

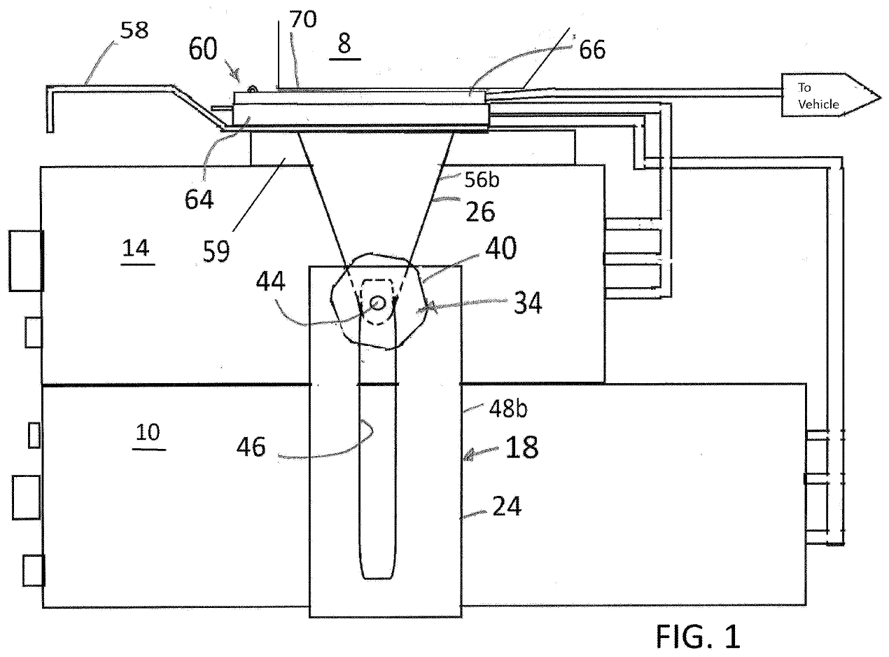

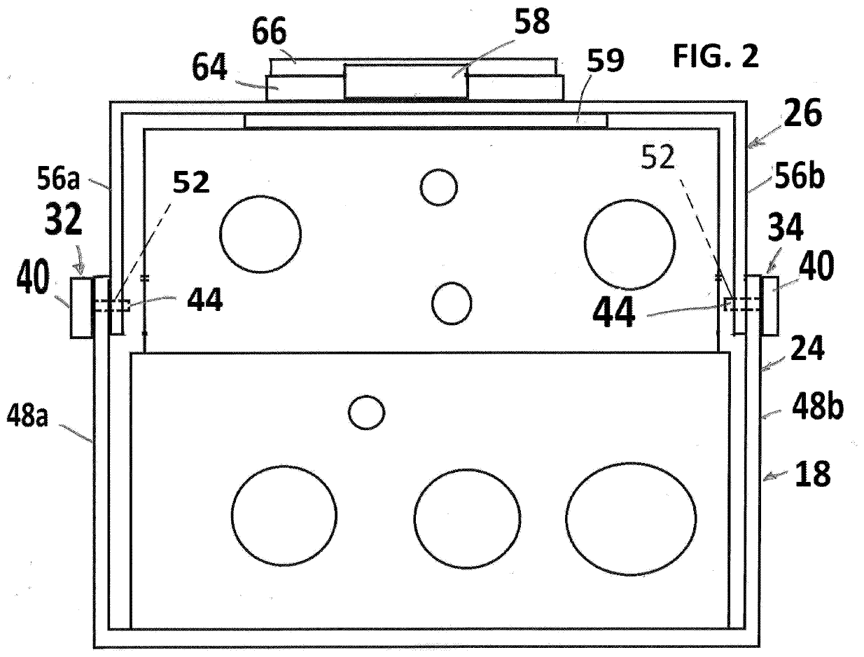

FIG. 1 illustrates an exemplary embodiment mounting arrangement for stacked components for vehicle mounting in a vehicle 8. The arrangement includes a lower first component 10 and an upper second component 14. The components can be police and fire scanners, Amateur Radio Band (Ham), Citizens Band (CB), Family Radio Service (FRS), General Mobile Radio Service (GMRS), simple stereo receivers, a speaker, amplifiers, or navigation systems.

The first and second components 10, 14 are held together by a bracket assembly 18. The bracket assembly 18 includes a U-shaped base bracket 24 and an overlying, inverted U-shaped upper bracket 26. The two brackets 24, 26 are fixed together by left and right fasteners 32, 34 which each include a turning knob 40 that extends into a threaded stud 44. The threaded stud extends through a slot 46 in left and right vertical legs 48a, 48b of the base bracket 24 and is threaded into a threaded hole 52 in each of left and right vertical legs 56a, 56b of the upper bracket 26. The slots 46 provide for vertical adjustment between the brackets 24, 26 to accommodate components 10, 14 of different height dimensions.

A handle 58 is attached or formed with the upper bracket 26.

A pad 59 can be arranged between the upper component and the upper bracket 26, which can be compressed to retain the stacked components snugly within the bracket assembly 18.

A plug and socket assembly 60 is provided above the upper bracket 26. The plug and socket assembly 60 includes a lower plug assembly 64 fixed to the upper bracket 26 and an upper socket assembly 66 fixed to a surface 70 of the vehicle 8. such as an under-dash surface.

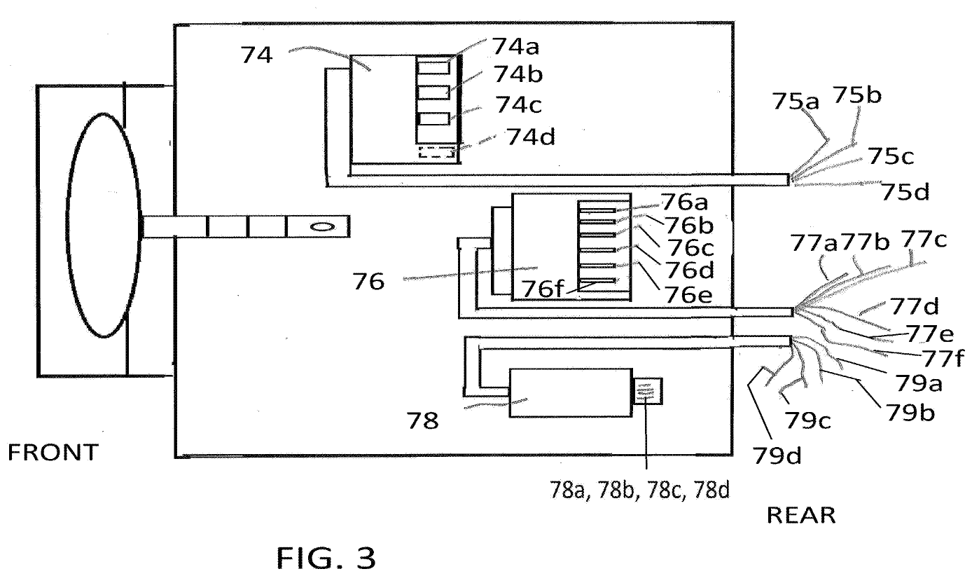

As shown in FIG. 3, the lower plug assembly 64 comprises a housing with an open top face and open front and rear ends. The lower plug assembly 64 includes a first plug 74, a second plug 76 and a third plug 78. The plugs 74, 76, 78 are multi-conductor plugs. The first plug 74 includes pins 74a, 74b, 74c, 74d, and corresponding wires 75a, 75b, 75c, 75d. The second plug 76 includes pins 76a, 76b, 76c, 76d, 76e, 76f. and corresponding wires 77a, 77b, 77c, 77d, 77e, 77f. The plug 78 is a Universal Serial Bus (“USB”) plug, such as standard USB, mini-USB or micro-USB plug, or USB-C plug and has four pins 78a, 78b, 78c, 78d, which connect to 79a, 79b, 79c, 79d.

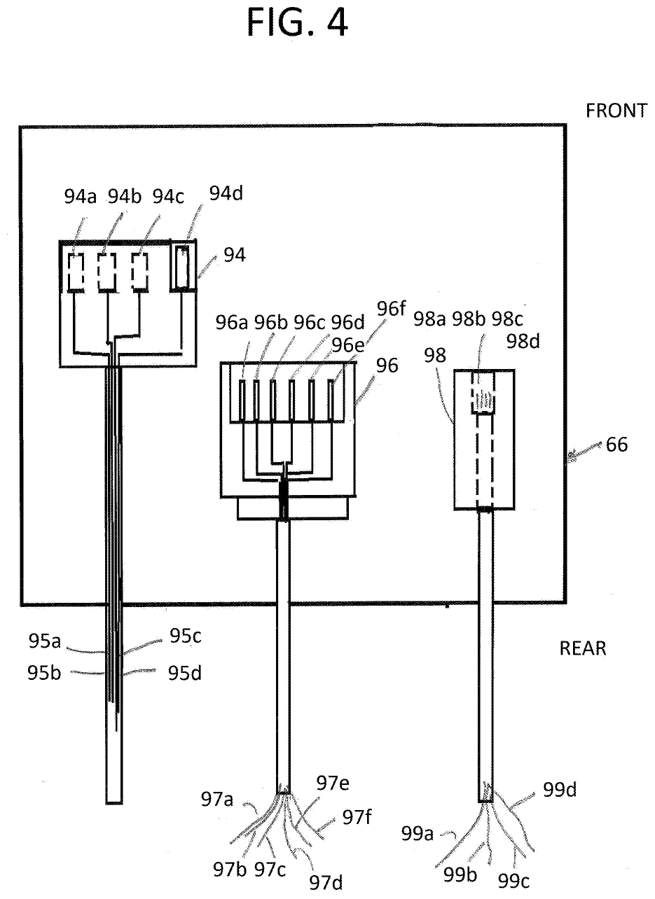

As shown in FIG. 4, the upper socket assembly 66 comprises a housing with an open bottom face and open rear and front ends. The upper socket assembly 66 includes a first socket 94, a second socket 96 and a third socket 98. The sockets 94, 96, 98 are multi-conductor sockets. The first socket includes pin connectors 94a, 94b, 94c, 94d. and corresponding wires 95a, 95b, 95c, 95d. The second socket 96 includes pin connectors 96a, 96b, 96c, 96d, 96e, 96f. and corresponding wires 97a, 97b, 97c, 97d, 97e, 97f. The socket 98 is a USB socket compatible with the USB plug 78 and has four pin connectors 98a, 98b, 99c, 98d connected to corresponding wires 99a, 99b, 99c, 99d.

The lower plug assembly 64 and the upper socket assembly 66 form a “clam shell’ arrangement with the upper socket assembly partially fitting vertically into the lower plug assembly, such that when slid together in a horizontal direction, the housings of the plug assembly and the lower socket assembly cover the top and bottom of the plugs and sockets.

The plugs and sockets of the upper socket assembly and the lower plug assembly are arranged within the upper socket assembly and the lower plug assembly, such that when the lower socket assembly is slid onto the upper plug assembly the plugs mate with respective sockets to make electrical connections. The plug 74 mates with the socket 94, the plug 76 mates with the socket 96, the plug 78 mates with the socket 98. The pins and pin connectors within each of the respective plugs and sockets make electrical connection per the Table A. below. The conductors are assigned the functions set forth in the Table A.

TABLE A

| Plug | Wires | Service | To/From |
|---|---|---|---|
| 74a | 75a | scanner signal (+) | to scanner component |
| 74b | 75b | scanner signal (−) | to scanner component |
| 74c | 75c | amplifier power (+) | to amplifier power input |
| 74d | 75d | amplifier power (−) | to amplifier power input |
| 76a | 77a | radio signal (+) | from amplifier input |
| 76b | 77b | radio signal (−) | from amplifier input |
| 76c | 77c | Radio power (+) | Radio power input |
| 76d | 77d | Radio power (−) | Radio power input |
| 76e | 77e | PA/External speaker (+) | Radio output |
| 76f | 77f | PA/External speaker (−) | Radio output |
| 78a | 79a | GPS signal (+) | to GPS device input |
| 78b | 79b | GPS signal (−) | to GPS device input |
| 78c | 79c | GPS power (+) | to GPS power input |
| 78d | 79d | GPS power (−) | to GPS power input |
| Socket | Wires | Service | To/From |
| 94a | 95a | scanner signal (+) | from scanner antenna |
| 94b | 95b | scanner signal (−) | from scanner antenna |
| 94c | 95c | amplifier power (+) | from vehicle power |
| 94d | 95d | amplifier power (−) | from vehicle power |
| 96a | 97a | radio signal (+) | from CB antenna |
| 96b | 97b | radio signal (−) | from CB antenna |
| 96c | 97c | Radio power (+) | from vehicle power |
| 96d | 97d | Radio power (−) | from vehicle power |
| 96e | 97e | PA/External speaker (+) | from Radio output |
| 96f | 97f | PA/External speaker (−) | from Radio oiutput |
| 98a | 99a | GPS signal (+) | from GPS antenna |
| 98b | 99b | GPS signal (−) | from GPS antenna |
| 98c | 99c | GPS power (+) | from vehicle power |
| 98d | 99d | GPS power (−) | from vehicle power |

The “Radio” in the above table can refer to CB Radio, or Amateur Radio or Family Radio Service, or General Mobile Radio Service. The “scanner” can be a police and fire scanner or other type scanner.

The conductors of the lower plug assembly 64 are connected to components 10 and 14 as set forth in Table A. The conductors have corresponding electrical connectors for connecting to inputs and outputs of components 10 and 14 or are hard wired thereto onto terminals without a connector.

The conductors of the upper socket assembly are connected to inputs and outputs of the vehicle as set forth in Table A. The conductors have corresponding electrical connectors, as applicable for connecting to inputs and outputs of the vehicle or are hard wired into the vehicle electric system, or are hard wired to vehicle-carried or mounted antennas.

In operation, the assembly of components 10, 14, the bracket assembly 18 and the lower plug assembly 64 as a unit are slid into a dedicated space in the vehicle 8, such as under the dash or console, using the handle 58. The upper socket assembly 66 is pre-attached to a position in the dedicated space of the vehicle 8 at the proper elevation.

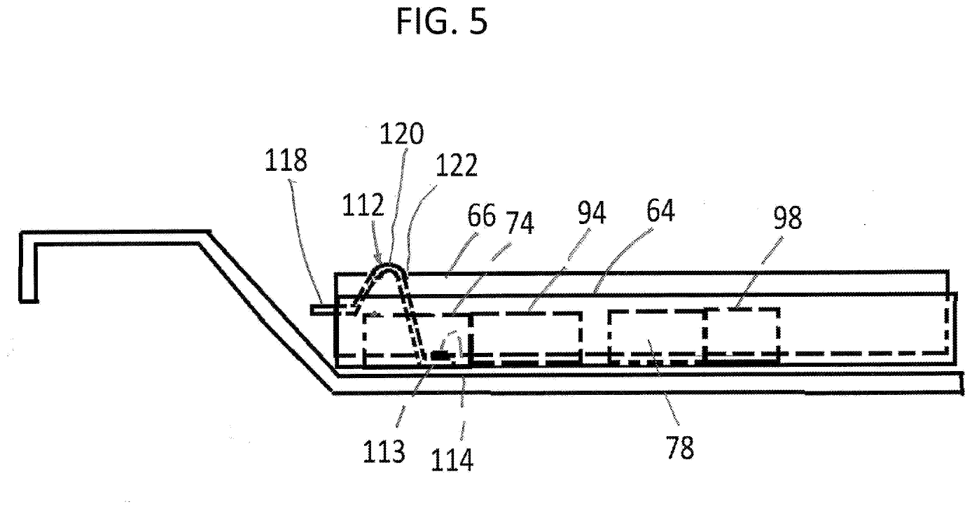

As shown in FIG. 5, the lower plug assembly 64 is slid under the upper socket assembly 66 and the plugs and sockets within the respective lower plug assembly 64 and the upper socket assembly 66 engage and mate together, such as the plug 74 mating with the socket 94, and the plug 78 mating with the socket 98, and the plug 76 mating with the socket 96 (not shown), to complete all the electrical connections.

Also shown in FIG. 5 is a leaf-spring latch 112 formed of a bent single piece of spring metal, and having a base 113 at one end that is riveted or otherwise attached to the floor of the lower plug assembly, such as by a rivet 114. At an opposite end of the latch, is a tab 118 and between the tab 118 and the base 113 is a fold or loop 120 which snaps into a slot 122 in the upper socket assembly 66. To slide the assembly of components 10, 14, bracket assembly 18 and lower plug assembly 64 into place, the lower plug assembly, attached to the upper bracket 26, is slid under the upper socket assembly 66 and the latch is depressed to allow the lower plug assembly 64 to fully engage with the upper socket assembly wherein the latch 112 is resiliently deflected downward and upon full engagement snaps upward into the slot 122.

Removal of the assembly of components 10, 14, the bracket assembly 18 and the lower plug assembly 64 as a unit is reversed, in that the tab 118 is depressed by the user's finger while the handle 58 is pulled to disengage the upper socket assembly from the lower plug assembly.

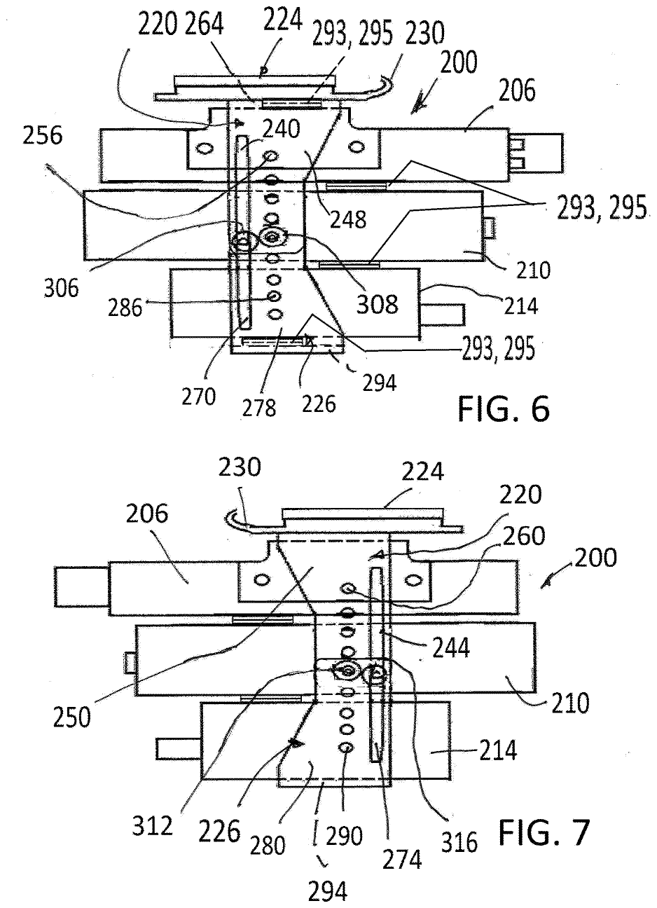

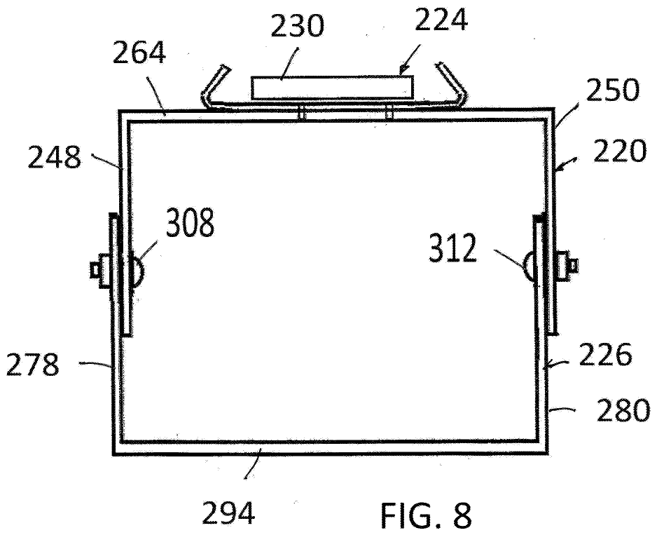

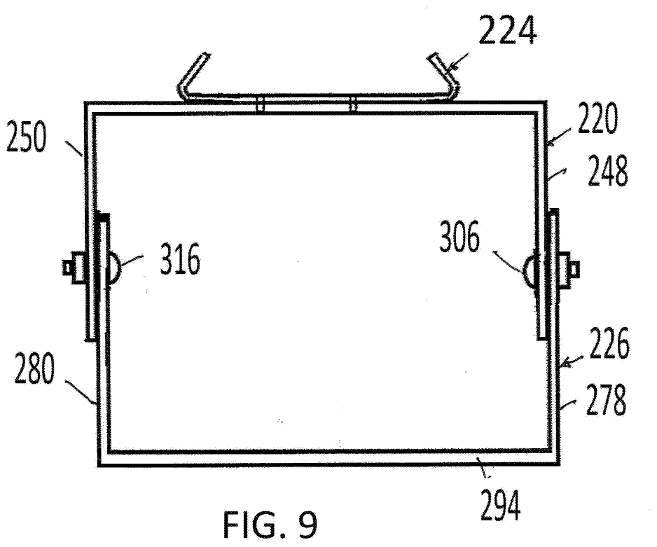

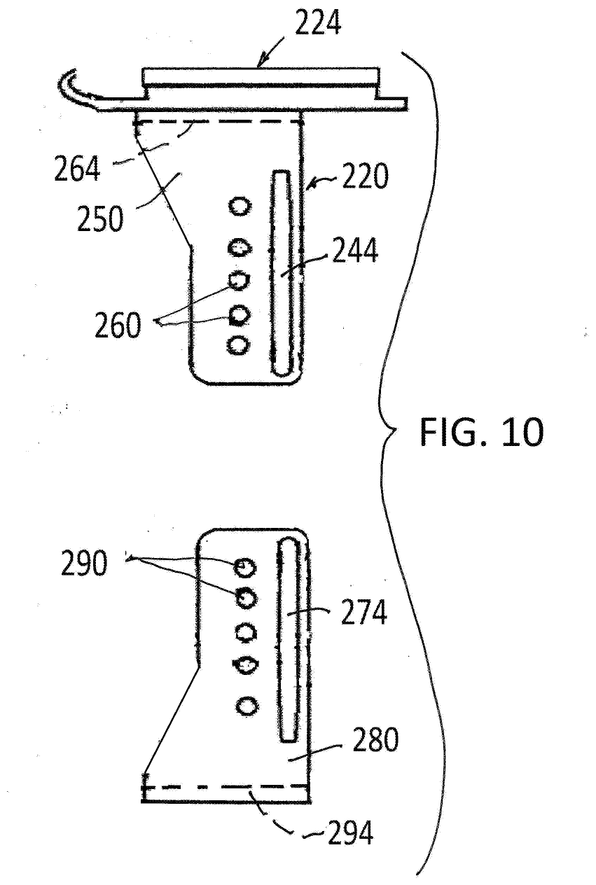

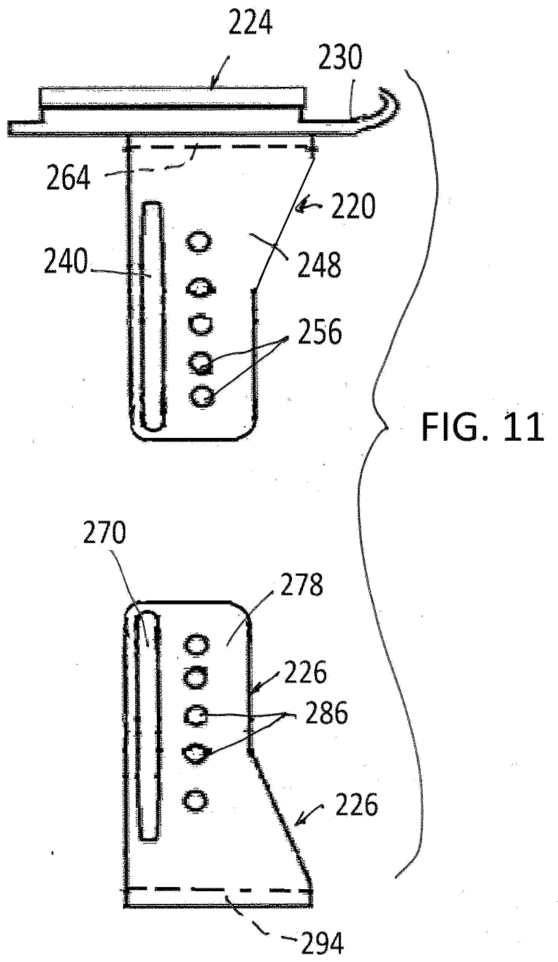

FIGS. 6-16 illustrate another embodiment of the invention. A bracket-and-component assembly 200 includes three components, such as a radio 206, an antenna tuner 210, a signal amplifier 214, a top, inverted U-shaped bracket 220, a bracket plug assembly 224, and a bottom U-shaped bracket 226. The bracket plug assembly 224 includes a pull handle 230.

The top, inverted U-shaped bracket 220 and the bottom U-shaped bracket each include vertical slots and a vertical column of holes.

The top, inverted U-shaped bracket 220 includes slots 240, 244 on side panels 248, 250 respectively. Adjacent to the slots 240, 244 is a column of vertically spaced apart holes 256, 260 respectively. The bracket plug assembly 224 is fastened securely to a top panel 264 of the inverted, U-shaped bracket 220.

The bottom U-shaped bracket 226 includes slots 270, 274 on side panels 278, 280 respectively. Adjacent to the slots 270, 274 is a column of vertically spaced apart holes 286, 290 respectively. The bottom bracket includes a bottom panel 294.

The side panels 248, 250, 278, 280 of the U-shaped brackets 220, 226 are overlapped and then fastened together around the components 206, 210, 214, using two fasteners on each side. On the left side, fasteners 306, 308 extend through the slots 240, 270 and one pair of aligned holes 256, 286, respectively, and tightened against the side panels 248, 278. On the right side, fasteners 312, 316 extend through the slots 244, 274 and one pair of aligned holes 260, 290, respectively, and tightened against the side panels 250, 280.

The radio 206, the antenna tuner 210, and the signal amplifier 214 can be secured to the top, inverted U-shaped bracket and the bottom U-shaped bracket by the use of co-acting hook and loop fastener strips 293, 295 placed between each of the radio 206, the antenna tuner 210, and the signal amplifier 214 and the adjacent one of the radio 206, the antenna tuner 210, and the signal amplifier 214 and to an underside of the top panel 264 and a top side of the bottom panel 294. Alternatively, fastening or clamping can be used to secure the radio 206, the antenna tuner 210, and the signal amplifier 214 to the top, inverted U-shaped bracket 220 and the bottom U-shaped bracket 226.

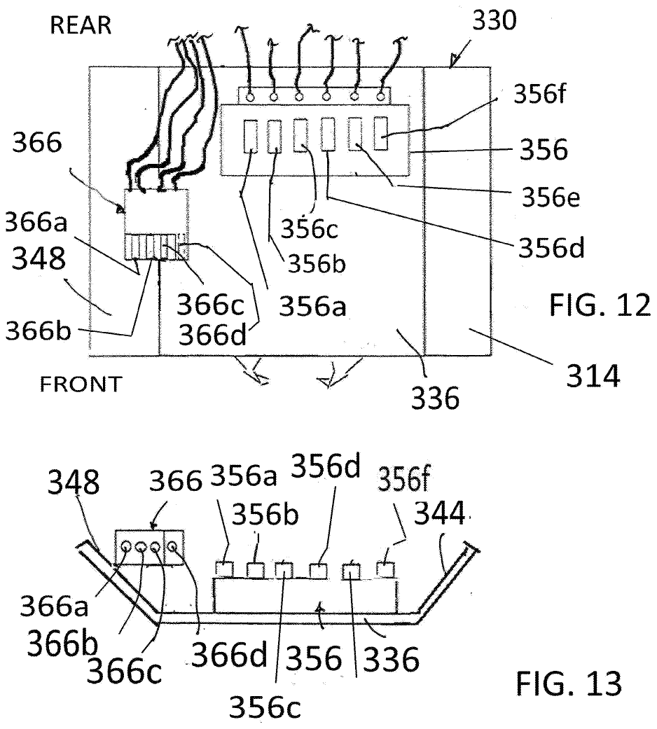

FIGS. 12-13 illustrate a vehicle plug assembly 330. The assembly 330 includes a base wall 336 and two sidewalls 344, 348. The sidewalls each extend obliquely from the base wall and extend outwardly and downwardly (shown as upwardly in the inverted orientation of FIGS. 12 and 13). A terminal block 356 is fixed to the base wall 336, by fasteners or adhesive or like connection means. The terminal block 356 includes six terminals 356a, 356b, 356c, 356d, 356e, 356f which each include a corresponding terminal screw for electrical connection of wires to each terminal. The terminals are raised and flexible to engage corresponding like terminals of the bracket plug 224, described in detail below. A plug 366 is fixed to one sidewall 348, elevated from the base wall 336, with pins and a socket facing a front of the vehicle pug assembly 330. The plug includes pins 366a, 366b, 366c and socket 366d.

All of the wires from the terminal block 356 and the plug 366 are routed and connected to connections on the vehicle as applicable.

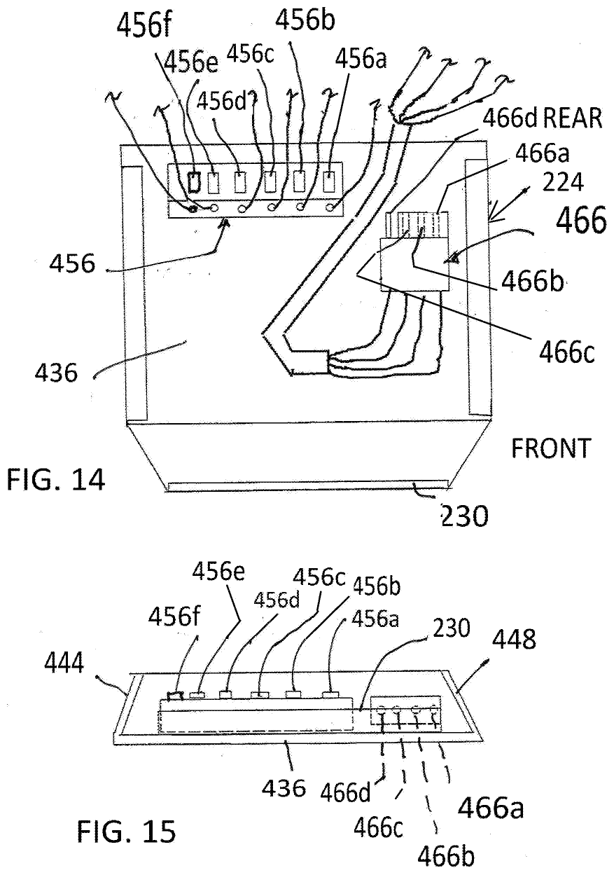

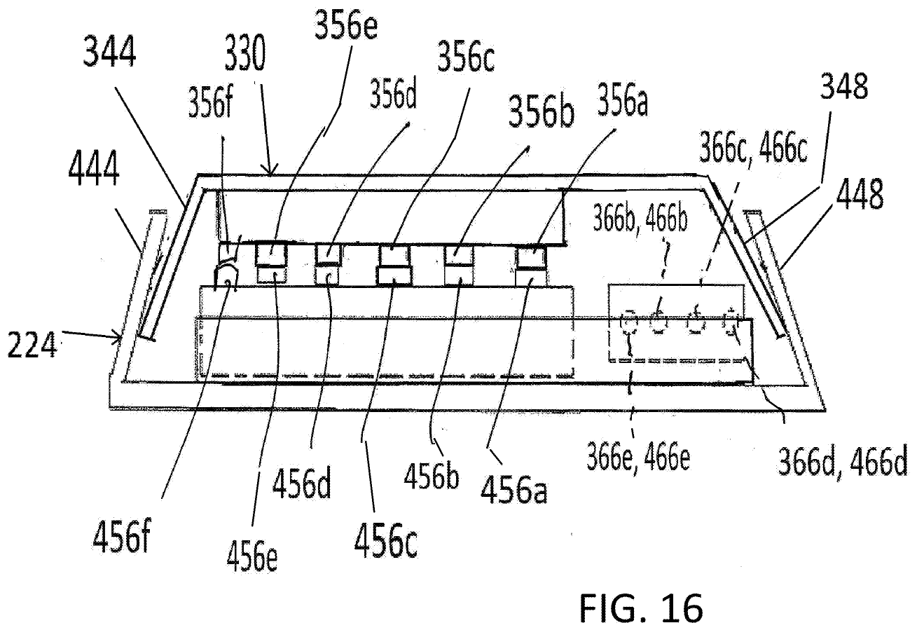

FIGS. 14-15 illustrate the bracket plug assembly 224. The assembly 224 includes a base wall 436 and two sidewalls 444, 448. The sidewalls each extend obliquely from the base wall and extend inwardly and upwardly. A terminal block 456 is fixed to the base wall 436, by fasteners or adhesive or like connection means. The terminal block 456 includes six terminals 456a, 456b, 456c, 456d, 456e, 456f which each include a corresponding terminal screw for electrical connection of wires to each terminal. The terminals are raised and flexible to engage corresponding terminals 356a, 356b, 356c, 356d, 356e, 356f of the terminal block 356 of the vehicle plug assembly 330 when the plug assemblies 224, 330 are engaged by sliding the bracket plug assembly under the vehicle plug assembly as shown in FIG. 16. A plug 466 is fixed to one sidewall 348, elevated from the base wall 436, with a pin and sockets facing a rear of the bracket plug assembly 224. The plug includes a pin 466d, and three sockets 466a, 466b, and 466c.

All of the wires from the terminal block 456 and the plug 466 are routed and connected to rear electrical connections of the radio 206, the antenna tuner 210, and the signal amplifier 214, as applicable.

The terminals 356a is connected to vehicle power (such as 12 V DC) and connects the power to terminal 456a, to power the radio and antenna tuner. The terminal 356b is connected to vehicle ground and is connected to terminal 456b to provide a ground to the radio and antenna tuner. The terminals 356c and 356d are signal connected to the vehicle loudspeaker and are connected to terminals 456c, 456d which are speaker output terminals of the radio. Terminals 356e and 356f are signal connected to a first vehicle antenna for high frequencies. Terminals 356e and 356f are electrically connected to terminals 456e and 456f which are electrically connected to the main radio antenna.

Plug pins 366a, 366b are connected to the vehicle second antenna for FM frequencies and connect with sockets 466a, 466b which are connected to the radio. Pin 366c and socket 366d are connected to vehicle ground and power (such as 12 V DC) respectively and are connected to socket 466c and pin 466d to provide power to the amplifier.

FIG. 16 illustrates the bracket plug assembly 224 engaged with the vehicle plug assembly 330 with the terminals 356a, 356b, 356c, 356d, 356e and 356f landed on the terminals 456a, 456b, 456c, 456d, 456e and 456f respectively when the bracket plug assembly is slid onto the vehicle plug assembly when the bracket-and-components assembly is slid as a unit into its position in the vehicle. The plugs 366 and 466 are also automatically engaged when the bracket plug assembly is slid onto the vehicle plug assembly when the bracket-and-components assembly is slid as a unit into its position in the vehicle. The plug pins 366a, 366b are connected with sockets 466a, 466b, the pin 366c and socket 366d are connected to socket 466c and the pin 466d.

As shown in FIG. 16, the sidewalls 344, 348 of the vehicle plug assembly 330 are sized, spaced apart and angled to form a resilient frictional fit between the sidewalls 444, 448 of the bracket plug assembly 224.

From the foregoing, it will be observed that numerous variations and modifications may be effectuated without departing from the spirit and scope of the invention. It is to be understood that no limitation with respect to the specific apparatus illustrated herein is intended or should be inferred.

The invention claimed is:

1. A mounting arrangement for a vehicle, for mounting three components in a stack, and allowing for removal of the arrangement and components together and installation of the arrangement and components together.

2. The arrangement according to claim 1, comprising a bracket assembly for mounting the three components together, and a first electrical multi-connector mounted to a vehicle and a second multi-connector mounted to the bracket assembly, wherein positioning the bracket assembly with the three mounted components automatically engages the first electrical multi-connector with the second electrical multi-connector.

3. The arrangement according to claim 2, wherein the bracket assembly comprises a first U-shaped bracket, and a second inverted U-shaped bracket, the vertical legs of the first U-shaped bracket are vertically adjustably connected to respective vertical legs of the second, inverted U-shaped bracket.

4. The arrangement according to claim 2, wherein the three components comprise a radio, an antenna tuner and a signal amplifier.

5. The arrangement according to claim 3, wherein each of the three components is wired to either another of the three components or to the second electrical multi-connector and vehicle electrical connections for the three components is wired to the first multi-electrical connector.
